(19) United States
(12) Patent Application Publication
(10) Pub. No.: US 2026/0159703 A1
(43) Pub. Date: Jun. 11, 2026

(54) IMPACT RESISTANT COMPOSITIONS AND APPARATUSES, AND METHODS OF PRODUCING THE SAME

(71) Applicant: Safire Technology Group, Inc., McLean, VA (US)

(72) Inventors: Maebh O'NEILL, Knoxville, TN (US); Sanzida SULTANA, Oak Ridge, TN (US); Beth ARMSTRONG, Oak Ridge, TN (US); Andrew HANNA, Knoxville, TN (US); Joshua CISCO, Knoxville, TN (US)

(21) Appl. No.: 19/351,553

(22) Filed: Oct. 7, 2025

Related U.S. Application Data
(60) Provisional application No. 63/729,689, filed on Dec. 9, 2024.

(51) Int. Cl. C09D 5/04; C09D 7/40; C09D 7/61; H01M 50/434; H01M 50/443; H01M 50/446; H01M 50/449

(52) U.S. Cl. CPC C09D 5/04; C09D 7/61; C09D 7/67; C09D 7/68; H01M 50/434; H01M 50/443; H01M 50/446; H01M 50/449

(57) ABSTRACT

Embodiments described herein relate to passively impact-resistant porous assemblies, electrochemical cells incorporating these assemblies, and methods for their manufacture. The assembly includes a porous substrate having a surface and defining pores therein, and a plurality of shear thickening particles. A first portion of the plurality of shear thickening particles is disposed on or over the surface, and a second portion is disposed at least partially in the pores. The second portion includes less than 10% of the total mass of the first and second portions of the shear thickening particles. Upon impact, the plurality of shear thickening particles can form agglomerates while suspended in a liquid or semi-liquid composition, causing to increase in viscosity of the liquid composition, thereby enhancing durability and impact resistance.

### CROSS-REFERENCE TO RELATED APPLICATION

This application claims priority to and benefit of U.S. Provisional Patent Application No. 63/729,689, filed Dec. 9, 2024, entitled “Impact Resistant Compositions And Apparatuses, And Methods Of Producing The Same,” the disclosure of which is hereby incorporated by reference herein in its entirety.

### STATEMENT OF GOVERNMENT SUPPORT

The Government has rights in this invention pursuant to Strategic Partnership Projects Agreement NFE-23-09487.

### TECHNICAL FIELD

Embodiments described herein relate generally to passively impact-resistant coatings and their application on substrates, such as separators. Specifically, embodiments described herein pertains to passively impact-resistant assemblies, the methods for their fabrication, and their implementation within electrochemical cells.

### BACKGROUND

The advancement and widespread adoption of high-energy battery technology are significantly hampered by issues related to the stability and safety of electrolyte systems. Modern advanced batteries typically utilize electrolytes including aprotic organic liquids such as dimethyl carbonate, ethylene carbonate, and propylene carbonate. While these substances facilitate effective energy storage, they also pose substantial safety risks due to their high volatility and flammability. A significant risk arises when an electrical short circuit occurs between the cathode and anode, potentially releasing a large amount of energy in a very short time. This rapid energy discharge can cause extreme local heating, and if the temperature exceeds the electrolyte's ignition point, it may result in fire or explosion. Such incidents have led to expensive product recalls, diminished consumer confidence, and hindered the growth of the emerging battery industry.

Despite incorporating several safety mechanisms, the potential for failure, though minimal, remains a concern. Some conventional methods include protective shrouds to prevent physical penetration of objects into battery compartments that can cause shorting. However, the flammability of aprotic organic electrolytes continues to pose a significant challenge to the extensive use of advanced batteries, especially in fields such as automotive and aeronautics. Enhancing the safety and stability of electrolyte systems is therefore important for the sustainable growth and acceptance of high-energy storage technologies.

### SUMMARY

Embodiments described herein relate to passively impact-resistant assemblies, methods of manufacturing the same, and the use thereof in electrochemical cells. Embodiments provided herein further relate to electrochemical cells incorporating passively impact-resistant electrolytes obtained from contacting an electrolyte with a passively impact-resistant assembly such as a separator configured to be disposed within an electrochemical cell.

In some embodiments, a passively impact-resistant assembly includes a surface defining pores therein; and a plurality of shear thickening particles disposed on or over the surface and the pores. The plurality of shear thickening particles are configured to form agglomerates upon receiving an impact while suspended in a liquid or semi-liquid composition.

In some embodiments, a passively impact-resistant assembly includes a surface defining pores therein; and a plurality of shear thickening particles. A first portion of the plurality of shear thickening particles are disposed on or over the surface, and a second portion of the plurality of shear thickening particles are disposed at least partially in the pores of the porous substrate. In some embodiments, the second portion of the plurality of shear thickening particles include less than 10% of the total mass of the first portion and the second portion of the shear thickening particles. The first portion of the shear thickening particles are configured to form agglomerates upon receiving an impact while suspended in a liquid or semi-liquid composition.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is an illustration of a passively impact-resistant assembly, according to an embodiment.

FIG. 2 is an illustration of a passively impact-resistant assembly, according to an embodiment.

FIG. 3A is an illustration of an electrochemical cell with a passively impact-resistant assembly, according to an embodiment; FIG. 3B is an illustration of an electrochemical cell with the passively impact-resistant assembly of FIG. 3A after addition of an electrolyte composition, according to an embodiment; and FIG. 3C is an illustration of an electrochemical cell of FIG. 3B after receiving an impact.

FIG. 4 is a block diagram of a method for forming electrochemical cell with a passively impact-resistant electrolyte, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate to passively impact-resistant assemblies, methods of manufacturing the same, and their use in electrochemical cells. The passively impact-resistant assemblies described herein may be coated with a passively impact-resistant suspension composition including a plurality of shear thickening particles. In some embodiments, the passively impact-resistant suspension composition is in a form of a thin film. In some embodiments, the passively impact-resistant suspension composition includes a binder (e.g., a polymeric binder). In some embodiments, upon contact with an electrolyte composition, the shear thickening particles within the suspension composition are configured to migrate into the electrolyte composition.

As used herein, the term “passively impact-resistant assembly” refers to a substrate loaded and/or coated with a composition (such as a slurry, a suspension, or an emulsion) including a plurality of shear-thickening particles. The plurality of shear-thickening particles when loaded into, and/or disposed (e.g., coated) onto the substrate can migrate or transition into a liquid or semi-liquid composition (e.g., an electrolyte composition) to form a “passively impact-resistant composition” such as passively impact-resistant electrolyte composition. Without being bound by any particular theory, the passively impact-resistant composition can undergo a passive shear thickening phenomenon upon application of an external force (e.g., experienced during a collision), such that the composition becomes resistant to impact forces to provide passive resistance against mechanical damage).

As used herein, the term “shear thickening” refers to an increase in viscosity of a liquid or semi-liquid composition (e.g., by at least an order of magnitude from the viscosity of the composition prior to application of an external force, such as an impact force) in which the shear thickening particles disperse in response to experiencing the external force. Shear thickening involves the rapid organization of shear thickening particles with the application of stress.

The embodiments provided herein further relate to electrochemical cells incorporating passively impact-resistant electrolyte composition (i.e., electrolyte composition including a plurality of shear thickening particles). In some embodiments, the passively impact-resistant electrolyte compositions can be obtained from contacting an electrolyte composition with a passively impact-resistant assembly. Upon contact of the passively impact-resistant assembly with the electrolyte composition, the plurality of shear thickening particles loaded into and/or coated onto a substrate can migrate from the assembly into the electrolyte composition to forma passively impact-resistant electrolyte composition. The passive shear thickening effect may not occur until the exertion of an external force on the passively impact-resistant electrolyte composition (e.g., during an impact or intrusion of an object into the electrochemical cell). Passive shear thickening may enable the electrolyte composition to form a solid or at least partially solid barrier which inhibits a cathode of the electrochemical cell from contacting an anode thereof, thus circumventing a potentially catastrophic electrical short. Because the shear thickening effect is passive, i.e., occurs autonomously without active manipulation of the electrolyte composition, expensive electronic monitoring may not be used, thus simplifying electrochemical cell construction and reducing manufacturing costs. Moreover, the liquid-like nature of the electrolyte composition may enhances its compatibility with conventional electrochemical cell manufacturing technology.

One challenge faced by high-energy battery technology includes the stability and safety of the electrolyte system included in the batteries or electrochemical cells. In advanced batteries, the electrolyte typically includes aprotic organic liquids, such as dimethyl carbonate, ethylene carbonate, and/or propylene carbonate. These substances facilitate effective energy storage but pose safety risks due to their volatility and combustibility. A safety hazard linked to these electrolytes is their tendency to catch fire when an electrical short occurs between the cathode and anode of the battery. This short can release a large amount of energy, causing severe localized heating. If the temperature exceeds the electrolyte's ignition point, it can trigger a fire. Thus, it is desirable to reduce the likelihood of electrical shorts that can lead to electrolyte combustion and/or thermal runaway.

In some implementations, passively impact-resistant composite electrolyte compositions can reduce the risk of electrolyte combustion caused as a result of mechanical impact. Such compositions leverage the passive shear thickening phenomenon as described herein, which provides significant resistance to mechanical damage upon the application of external force. Examples of such electrolytes compositions are described in U.S. Pat. No. 9,590,274, (“the '274 patent”) filed Sep. 26, 2014, entitled “Impact Resistant Electrolytes,” the disclosure of which is incorporated herein by reference in their entirety.

However, fabrication of electrochemical cells including such passively impact-resistant composite electrolyte composition presents some challenges. Typically, electrolytes are liquids and are injected into a dry, pre-assembled cell where the electrolyte wets and fills the cell and separator structure. However, such electrolyte infusion methods may not be amenable for a shear thickening electrolyte because the force of injection may cause it transition into a solid, thus inhibiting flow and filling of pores within the electrochemical cell (e.g., pores of a separator, a cathode, or an anode). Second, the solvent part of the shear thickening electrolyte may be selectively wicked into the cell and the shear thickening particles may not be distributed in the cell homogenously, which may be desirable for impact and thermal safety. This can also cause an increase in solution viscosity acerbating the thickening issue.

Moreover, some methods of incorporating shear thickening electrolyte compositions may include incorporating specific separator materials with pore sizes large enough to accommodate 20-40 wt. % of shear thickening particles. Such methods may be limited to pore diameters of porous substrates having pore diameters ranging from 1 to 100 times the average agglomerate diameter of the shear thickening particles. However, the separators currently used in the automotive and other industries generally do not meet these criteria. Moreover, particles can be dislodged from the separator material during handling, shipping, or storage. This issue is mostly due to the absence of a binder, which increases the likelihood of particle displacement.

In contrast, embodiments of the system and methods described herein offer multiple benefits, including, for example, improving the safety and stability of electrochemical cells by inhibiting electrical shorts through passive shear thickening, as described herein. This approach addresses the shortcomings of conventional methods by enhancing compatibility with conventional battery manufacturing technologies and allowing for the integration of shear thickening particles with a broad range of separator materials. Additionally, the use of a binder material in the suspension of the shear thickening particles ensures that the shear thickening particles adhere to the surface of the separator throughout handling, shipping, and storage. Embodiments described herein enable application across various electrochemical cell types and obviates the use of expensive electronic monitoring or specialized separator materials, ensuring robustness during handling, shipping, and storage, and reducing manufacturing complexity and cost.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

As utilized herein, the terms “substantially’ and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

It should be noted that the term “for example” or “exemplary” as used herein to describe various embodiments is intended to indicate that such embodiments are possible examples, representations, and/or illustrations of possible embodiments (and such term is not intended to connote that such embodiments are necessarily extraordinary or superlative examples).

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

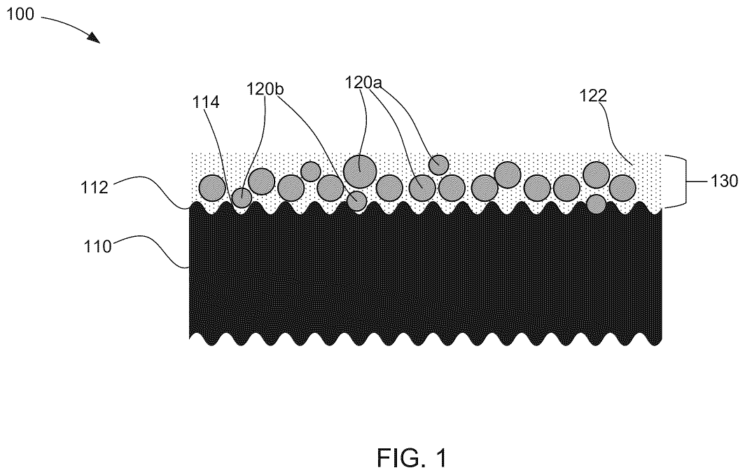

FIG. 1 is a side view of a passively impact-resistant assembly 100 (referred to herein as “assembly 100”), according to an embodiment. The assembly 100 includes a porous substrate 110 having a surface 112 and a plurality of pores 114 defined in the surface 112, the pores 114 being distributed throughout the surface 112. The assembly 100 further includes a plurality of shear thickening particles 120a and 120b (collectively referred to herein as “shear thickening particles 120”) and may optionally include a suspension composition 122 in which the plurality shear thickening particles 120 are suspended and/or dispersed. In some embodiments, a coating layer 130 including a plurality shear thickening particles 120 and the suspension composition 122 may be disposed on the surface 112, for example, coated on the surface 112. As shown in FIG. 1, a first portion of the plurality of shear thickening particles 120a are disposed on or over the surface 112, and a second portion of the plurality of shear thickening particles 120b are at least partially disposed within the pores 114. In some embodiments, the second portion of the plurality of shear thickening particles 120b includes (e.g., constitutes or makes up) less than 10% of the total mass of the shear thickening particles 120. In some embodiments, the second portion of the plurality of shear thickening particles 120b includes less than 5% of the total mass of the shear thickening particles 120. In some embodiments, the second portion of the plurality of shear thickening particles 120b can be in an amount of 0% of the plurality of shear thickening particles 120. That is, in some embodiments, no shear thickening particles are at least partially disposed within the pores 114.

In some embodiments, a mass percentage P of the second portion of the shear thickening particles 120b can be in an amount of 0 to 10%. The mass percentage P can be defined as the ratio of the mass of the second portion 120b to the total mass of the second portion 120b and the porous substrate 110, multiplied by 100. For example, the mass percentage P of the second portion of the shear thickening particles 120b can be represented by the following equation:

$$P = \frac{{mass}_{p 2}}{{mass}_{p 2} + {mass}_{separator}}$$

where massₚ₂ is the mass of the second portion of shear thickening particles 120b, and mass separator is the mass of the separator.

It is important to note that the construction and arrangement of shear thickening particles 120b shown in FIG. 1 are illustrative only. It should be appreciated that many modifications are possible (e.g., variations in sizes, dimensions, structures, shapes and proportions of the shear thickening particles, orientations, a ratio of the second portion of the plurality of shear thickening particles 120b to the first portion of the plurality of shear thickening particles 120a etc.) without materially departing from the novel teachings and advantages of the subject matter described herein. For example, in some embodiments, where the second portion of the plurality of shear thickening particles 120b include about 0 wt. % of the plurality of shear thickening particles 120, there might be no shear thickening particles 120 shown within the pores 114.

In some embodiments, when the passively impact-resistant assembly 100 comes into contact with a liquid or semi-liquid composition (e.g., a liquid electrolyte), the plurality of shear thickening particles 120 may migrate from the porous assembly 100 into the liquid or semi-liquid composition to form a passively impact-resistant liquid or semi-liquid composition (not shown). In some embodiments, the plurality of shear thickening particles within the passively impact-resistant liquid or semi-liquid composition is configured to form a plurality of agglomerates (not shown) upon receiving an impact. In some embodiments, the pores 114 have an average pore diameter, and the agglomerates have an average agglomerate diameter equal to or greater than the average pore diameter. In some embodiments, the pores 114 have an average pore diameter, and the agglomerates have an average agglomerate diameter greater than the average pore diameter.

In some embodiments, the porous substrate 110 may be electrically insulating. In some embodiments, the porous substrate 110 may be a conventional separator configured to provide electrical isolation between an anode and a cathode. As used herein, the term “conventional separator” refers to an ion permeable membrane, substrate, film, or layer(s) that provides electrical isolation between an anode and a cathode, while allowing charge carrying ions to pass therethrough. That is, in some embodiments, the porous substrate 110 may be a conventional separator that permits the transport of ions therethrough, while preventing the transfer of electrons.

The porous substrate 110 can be selected from many suitable designs and materials. The porous substrate 110 can be made from polymeric, glass fiber, ceramic and other suitable materials. In some embodiments, the porous substrate 110 can be in a form of a membrane, a film, or a base layer. In some embodiments, the porous substrate 110 may be a single layer (monolayer) or a multilayer (such as bi-layer or tri-layer or other multi-layer) membrane. In some embodiments, the porous substrate 110 can be in a form of a porous polymer membrane. In some embodiments, the porous substrate 110 is a porous polyolefin membrane. Exemplary polyolefins include, but are not limited to, polypropylene (PP), polyethylene (PE), polymethyl pentene (PMP) copolymers of any of the foregoing and mixtures thereof. In some embodiments, the porous substrate 110 includes at least one of polypropylene (PP), polyethylene (PE), or polymethyl pentene (PMP). In some embodiments, the porous substrate 110 may comprise multiple layers, with each layer independently formed from a polyolefin. In some embodiments, the porous substrate 110 can be selected from Celgard® brand membranes available from Celgard, LLC of Charlotte, N.C.

In some embodiments, the porous substrate 110 can have a thickness of at least about 10 nm, at least about 15 nm, at least about 20 nm, at least about 25 nm, at least about 30 nm, at least about 35 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, the separator can have a thickness of no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm. Combinations of the above-referenced thicknesses are also possible (e.g., at least about 10 nm and no more than about 20 μm or at least about 50 nm and no more than about 1 μm), inclusive of all values and ranges therebetween. In some embodiments, the insulating material can have a thickness of about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm.

In some embodiments, the porous substrate 110 can have a pore size of at least about 5 nm, at least about 10 nm, at least about 15 nm, at least about 20 nm, at least about 25 nm, at least about 30 nm, at least about 35 nm, at least about 40 nm, at least about 45 nm, at least about 50 nm, at least about 75 nm, at least about 125 nm, at least about 150 nm, at least about 175 nm, at least about 200 nm, at least about 250 nm, at least about 300 nm, at least about 350 nm, at least about 400 nm, at least about 450 nm, or at least about 500 nm. In some embodiments, the porous substrate 110 can have a pore size of no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 50 nm, or no more than about 25 nm. Combinations of the above-referenced pore sizes are also possible (e.g., at least about 5 nm and no more than about 4 μm or at least about 50 nm and no more than about 1 μm), inclusive of all values and ranges therebetween.

In some embodiments, the porous substrate 110 can have a porosity (i.e., porosity of the porous substrate 110 without the coating 130) of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, or at least about 85%. In some embodiments, the porous substrate 110 can have a porosity of no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10%. Combinations of the above-referenced porosity percentages of the porous substrate 110 are also possible (e.g., at least about 5% and no more than about 90% or at least about 20% and no more than about 40%), inclusive of all values and ranges therebetween. In some embodiments, the porous substrate 110 can have a porosity of about 5%, about 10%, about 15%, about 20%, about 25%, about 30%, about 35%, about 40%, about 45%, about 50%, about 55%, about 60%, about 65%, about 70%, about 75%, about 80%, about 85%, or about 90%.

The porosity of the porous substrate can decrease due to the introduction of the shear thickening enabling particles 120 into the pores 114 of the porous substrate 110. In some embodiments, the initial porosity (i.e., porosity of the porous substrate 110 without the coating 130) can be greater than the final porosity (i.e., porosity of the porous substrate 110 with the coating 130) of the porous substrate coated with the coating 130. It is desirable not to block all the pores 114 so that liquid electrolyte or gasses are able to penetrate totally through the structure. In some embodiments, the final porosity of the porous substrate 110 can be from 20% to 60%. The porosity of the porous substrate 110 needs to allow for ion transport across the porous substrate while performing the shear thickening function. In some embodiments, the final porosity of the porous substrate is greater than about 25%, greater than about 30%, greater than about 35%, greater than about 40%, greater than about 45%, greater than about 50%, greater than about 55%, or greater than about 60%, for example, for optimal battery performance.

In some embodiments, the porous substrate 110 can maintain its integrity (e.g., shape, porosity, pore shape, and pore sizes etc.) within a wide temperature range. In some embodiments, the porous substrate 110 can be mechanically stable without shrinkage or pore closing within a wide temperature range. In some embodiments, the porous substrate 110 can be functionally and/or mechanically stable at a temperature of at least about −70° C., at least about −60° C., at least about-50° C., at least about −40° C., at least about −30° C., at least about −20° C., at least about −10° C., at least about 0° C., at least about 20° C., at least about 40° C., at least about 60° C., at least about 80° C., at least about 100° C., at least about 120° C., at least about 140° C., at least about 160° C., at least about 180° C., at least about 200° C., at least about 220° C., at least about 240° C., at least about 260° C., at least about 280° C., at least about 300° C., at least about 320° C., at least about 340° C., or at least about 350° C. In some embodiments, the porous substrate 110 can be functionally and/or mechanically stable at a temperature of no more than about 400° C., no more than about 390° C., no more than about 380° C., no more than about 370° C., no more than about 360° C., no more than about 350° C., no more than about 340° C., no more than about 330° C., no more than about 320° C., no more than about 310° C., no more than about 300° C., no more than about 290° C., no more than about 280° C., no more than about 270° C., no more than about 260° C., no more than about 250° C., no more than about 200° C., no more than about 150° C., or no more than about 100° C. Combinations of the above-referenced temperatures are also possible (e.g., at least about −70° C. and no more than about 400° C. or at least about 0° C. and no more than about 350° C.), inclusive of all values and ranges therebetween.

In some embodiments, the porous substrate 110 may be coated with a thin film (not shown). In some embodiments, the thin film may include nanoparticles. In some embodiments, the thin film may have a thickness ranging from about 1 μm to about 15 μm.

The shear thickening particles 120 are capable of forming a plurality of agglomerates upon receiving an impact when the shear thickening particles 120 are suspended and/or dispersed in a liquid or semi-liquid composition. For example, when the surface 112 of passively impact-resistant assembly 100, where the plurality of shear thickening particles are distributed along, comes in contact with a liquid or semi-liquid composition, the shear thickening particles 120 can partially or fully diffuse or migrate from the assembly 100 into the liquid or semi-liquid composition. In some embodiments, while dispersed in the liquid or semi-liquid composition, the shear thickening particles 120 can lead to increase in viscosity of the electrolyte composition upon receiving an impact (e.g., collisions, vibrations, compressions, and/or shearing force). In some embodiments, viscosity of the liquid or semi-liquid composition can increase by at least two times, at least three times, at least four times, at least five times, at least six times, at least seven time, at least eight times, at least nine times, at least ten times, at least fifteen times, at least twenty times, at least twenty-five times, or at least thirty times, inclusive, from the viscosity of the composition prior to the impact.

In some embodiments, a viscosity of the liquid or semi-liquid composition can increase by at least an order of magnitude from the viscosity of the electrolyte composition prior to the impact. In some embodiments, the impact results in a shear rate of at least about 75 s⁻¹, at least about 80 s⁻¹, at least about 85 s⁻¹, at least about 90 s⁻¹, at least about 95 s⁻¹, at least about 100 s⁻¹, at least about 110 s⁻¹, at least about 120 s⁻¹, at least about 130 s⁻¹, at least about 140 s⁻¹, at least about 150 s⁻¹, at least about 160 s⁻¹, at least about 170 s⁻¹, at least about 180 s⁻¹, at least about 190 s⁻¹, at least about 200 s⁻¹, at least about 250 s⁻¹, or at least about 300 s⁻¹. Shear thickening involves the rapid organization of shear thickening particles 120 with the application of stress. The size of these particles resists flow making the material appear solid-like.

The shear thickening particles 120 can be formed from any suitable material that can lead to a formation of agglomerates that form a solid-like composition upon receiving an impact. In some embodiments, the shear thickening particles 120 can be made from at least one of a polymer or a ceramic. In one embodiment, the shear thickening particles 120 are made from a ceramic. In some embodiments, the shear thickening particles 120 are electrically non-conducting particles. In some embodiments, the electrically non-conducting particles are selected from at least one of TiO₂, Al₂O₃, ZrO₂, Y₂O₃, HfO₂, GeO₂, Sc₂O₃, CeO₂, MgO, BN, SiO₂, B₂O₃, Li₃N or Li₂S. In some embodiments, the shear thickening particles 120 can include silica particles. In some embodiments, the silica particles can be derived from diatomaceous earth. In some embodiments, the silica particles can be derived from the Stober process. In some embodiments, the shear thickening particles 120 are coated with a covalently bound, sterically repulsive polymer or a surfactant/dispersant or both.

The shear thickening particles 120 can have any suitable shape that allows proper dispersion (e.g., substantially homogenous dispersion) of the shear thickening particles 120 within a liquid composition. In some embodiments, the shear thickening particles 120 are spheroidal and/or spherical. As used herein, the term “spheroidal” means that the shape resembles that of a sphere but is not perfectly round (“quasi-spherical”), for example an ellipsoidal shape. The shape and size of shear thickening particles 120 may be identified by means of photographs taken by microscope, in particular using a device such as a transmission electron microscope (TEM) or scanning electron microscope (SEM).

In some embodiments, the shear thickening particles 120 can have an average particle size of at least about 50 nm, at least about 100 nm, at least about 150 nm, at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, or at least about 950 nm. In some embodiments, the shear thickening particles 120 can have an average particle size of no more than about 1 μm, no more than about 950 nm, no more than about 900 nm, no more than about 850 nm, no more than about 800 nm, no more than about 750 nm, no more than about 700 nm, no more than about 650 nm, no more than about 600 nm, no more than about 550 nm, no more than about 500 nm, no more than about 450 nm, no more than about 400 nm, no more than about 350 nm, no more than about 300 nm, or no more than about 250 nm. Combinations of the above-referenced particle sizes are also possible (e.g., at least about 50 nm and no more than about 1 μm, or at least about 300 nm and no more than about 900 nm), inclusive of all values and ranges therebetween. In some embodiments, the shear thickening particles 120 can have an average particle size of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1 μm.

In some embodiments, the shear thickening particles 120 can be selected to have a polydispersity index of no greater than 0.3. In some embodiments, the shear thickening particles 120 can have a polydispersity index of no greater than 0.2. In some embodiments, the shear thickening particles 120 can have a polydispersity index of no greater than 0.07.

In some embodiments, the shear thickening particles 120 can have an average particle size equal to or greater than an average pore diameter of the pores 114 of the assembly 100. In some embodiments, the shear thickening particles 120 can have an average particle size greater than an average pore diameter of the pores 114 of the assembly 100. In some embodiments, the shear thickening particles 120 can have an average particle size greater than an average pore diameter of the pores 114 of the assembly 100, and the second portion of the shear thickening particles 120b include less than about 5 wt %, less than about 4 wt %, less than about 3 wt %, less than about 2 wt %, less than about 1 wt %, less than about 0.5 wt %, or less than about 0.1 wt % of the plurality of shear thickening particles 120.

In some embodiments, the shear thickening particles 120 can be essentially free of materials that volatilize at low temperatures. The shear thickening particles 120 can be essentially free of materials that volatilize at 80° C. or more. The shear thickening particles 120 can be essentially free of materials that volatilize at 110° C. The shear thickening particles 120 can be essentially free of materials that volatilize at 120° C.

In some embodiments, the second portion of the shear thickening particles 120b can include at least about 0%, at least about 0.01%, at least about 0.05%, at least about 0.1%, at least about 0.5%, at least about 1%, at least about 2%, at least about 3%, at least about 4%, or at least about 5% by weight of the plurality of shear thickening particles 120. In some embodiments, the second portion of the shear thickening particles 120b can include no more than about 10%, no more than about 9%, no more than about 8%, no more than about 7%, no more than about 6%, no more than about 5%, no more than about 4%, no more than about 3%, no more than about 2%, or no more than about 1% by weight of the plurality of shear thickening particles 120. Combinations of the above referenced ranges of the weight percentages also possible (e.g., at least about 0% and no more than about 10% by weight or at least about 0.1% and no more than about 3% by weight), inclusive of all values and ranges therebetween.

In some embodiments, the shear thickening particles 120 form at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, or at least about 80% of the total weight of the porous substrate 110 and the shear thickening particles 120. In some embodiments, the shear thickening particles 120 form no more than about 90%, no more than about 85%, no more than about 80%, no more than about 75%, no more than about 70%, no more than about 65%, no more than about 60%, no more than about 55%, no more than about 50%, no more than about 45%, or no more than about 40% of the total weight of the porous substrate 110 and the shear thickening particles 120. Combinations of the above referenced percentages also possible (e.g., at least about 10% and no more than about 90% or at least about 20% and no more than about 80%), inclusive of all values and ranges therebetween.

In some embodiments, the loading of the shear thickening particles 120 within the suspension composition 122 may be high enough to leave enough particles to form a suitable colloidal network (the network including a plurality of agglomerates) with the introduction of a liquid composition (e.g., liquid battery electrolyte during cell formation). In some embodiments, if the particle loading is not high enough, there may not be enough particles to create shear thickening behavior during impact. On the other hand, if the particle loading is too high, then the colloids may fill all available space that will prevent the formation of shear thickening electrolyte behavior during operation of the battery.

In some embodiments, the shear thickening particles 120 can be present in the suspension composition 122 in an amount of at least about 20 wt. %, at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, or at least about 70 wt. %. In some embodiments, the shear thickening particles 120 can be present in the suspension composition 122 in an amount of no more than about 80 wt. %, no more than about 75 wt. %, no more than about 70 wt. %, no more than about 65 wt. %, no more than about 60 wt. %, no more than about 55 wt. %, no more than about 50 wt. %, no more than about 45 wt. %, no more than about 40 wt. %, no more than about 35 wt. %, no more than about 30 wt. %, no more than about 25 wt. %, or no more than about 20 wt. %. Combinations of the above-referenced weight percentages are also possible (e.g., at least about 20 wt. % and no more than about 80 wt. % or at least about 40 wt. % and no more than about 70 wt. %), inclusive of all values and ranges therebetween. In some embodiments, the shear thickening particles 120 can be present in the suspension composition 122 in an amount of about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, or about 80 wt. %, inclusive.

In some embodiments, the suspension composition 122 can have a viscosity of at least about 30 mPa, at least about 100 mPa, at least about 200 mPa, at least about 300 mPa, at least about 400 mPa, at least about 500 mPa, at least about 600 mPa, at least about 700 mPa, at least about 800 mPa, at least about 900 mPa, at least about 1,000 mPa, at least about 1,500 mPa, at least about 2,000 mPa, at least about 2,500 mPa, at least about 3,000 mPa, at least about 3,500 mPa, at least about 4,000 mPa, at least about 4,500 mPa, at least about 5,000 mPa, at least about 5,500 mPa, at least about 6,000 mPa, at least about 6,500 mPa, at least about 7,000 mPa, at least about 7,500 mPa, at least about 8,000 mPa, at least about 8,500 mPa, or at least about 9,000 mPa. In some embodiments, the suspension composition 122 can have a viscosity of no more than about 10,000 mPa, no more than about 9,500 mPa, no more than about 9,000 mPa, no more than about 8,500 mPa, no more than about 8,000 mPa, no more than about 7,500 mPa, no more than about 7,000 mPa, no more than about 6,500 mPa, no more than about 6,000 mPa, no more than about 5,500 mPa, no more than about 5,000 mPa, no more than about 4,500 mPa, no more than about 4,000 mPa, no more than about 3,500 mPa, no more than about 3,000 mPa, no more than about 2,500 mPa, no more than about 2,000 mPa, no more than about 1,500 mPa, no more than about 1,000 mPa, or no more than about 500 mPa. Combinations of the above-referenced viscosity values are also possible (e.g., at least about 30 mPa and no more than about 10,000 mPa or at least about 3,000 mPa and no more than about 9,000 mPa), inclusive of all values and ranges therebetween. In some embodiments, the suspension composition 122 can have a viscosity of about 30 mPa, about 100 mPa, about 200 mPa, about 300 mPa, about 400 mPa, about 500 mPa, about 600 mPa, about 700 mPa, about 800 mPa, about 900 mPa, about 1,000 mPa, about 1,500 mPa, about 2,000 mPa, about 2,500 mPa, about 3,000 mPa, about 3,500 mPa, about 4,000 mPa, about 4,500 mPa, about 5,000 mPa, about 5,500 mPa, about 6,000 mPa, about 6,500 mPa, about 7,000 mPa, about 7,500 mPa, about 8,000 mPa, about 8,500 mPa, about 9,000 mPa, about 9,500 mPa, or about 10,000 mPa.

In some embodiments, the suspension composition 122 can include at least one of a suspension solvent, a particle suspension agent, a water based binder, a polymeric binder, or a polymer. In some embodiments, the suspension composition 122 can further include a plurality of particles. The particles may be inorganic or organic particles. Non-limiting exemplary examples of organic particles are polymer materials or particles, such as, for example, polymer fibers, beads, chips, or the like.

In some embodiments, the suspension composition 122 is substantially free of a solvent. In some embodiments, the suspension composition 122 includes a suspension solvent. The suspension solvent can be any suitable solvent that will not react with the materials in the porous substrate 110 or the shear thickening particles 120 changing their morphology or chemical composition through dissolution of a component or residual impurities that could affect battery performance. The suspension solvent can be selected to have a dielectric constant in a range of about 5 to about 25 to ensure stabilization of the colloids in the suspension but not introduce shear thickening behavior. The suspension solvent can be any of several battery formulation solvents currently in use, or a solvent that is specifically selected for this purpose.

In some embodiments, the suspension solvent can have a boiling point that is low enough to facilitate evaporation and removal. In some embodiments, the suspension solvent can have a boiling point of less than about 150° C. In some embodiments, the suspension solvent can have a boiling point of less than about 130° C. In some embodiments, the suspension solvent can have a boiling point of less than about 110° C. In some embodiments, the suspension solvent can have a boiling point of less than about 90° C. In some embodiments, the suspension solvent may be selected based on dispersibility/wettability of the particles in the solvent as well as the vapor pressure of the solvents. In some embodiments, the solvent is selected or formulated to dry at an optimum rate, for example, at a drying rate that is slow enough to allow enough time for fabrication without drying out, and fast enough to inhibit sedimentation of the particles included in the coating.

In some embodiments, the suspension solvent can include at least one of acetic acid, acetone, acetonitrile, anisole, benzene, bromobenzene, carbon disulfide, carbon tetrachloride, chlorobenzene, chloroform, cyclohexane, dibutyl ether, o-dichlorobenzene, 1,2-dichloroethane, dichloromethane, diethylamine, diethyl ether, 1,2-dimethoxyethane, n,n-dimethylacetamide, n,n-dimethylformamide, dimethyl sulfoxide, 1,4-dioxane, ethanol, ethyl acetate, ethyl benzoate, formamide, hexamethylphosphoramide, isopropyl alcohol, methanol, 2-methyl-2-propanol, nitrobenzene, nitromethane, pyridine, tetrahydrofuran, toluene, trichloroethylene, triethylamine, trifluoroacetic acid, 2,2,2-trifluoroethanol, water, o-xylene, propylene carbonate, dimethyl carbonate, ethylene carbonate, n-methyl pyrrolidone, 3:7 EC/DMC, 50/50 ethanol/xylene, or 50/50 methanol/xylene.

In some embodiments, the suspension composition 122 can include a polymeric binder. In some embodiments, the polymeric binder can include at least one of polyvinylidene difluoride (PVDF), polyethylene terephthalate (PET), poly phenylene sulfide (PPS), poly ether-ether ketone (PEEK), polyimide (PI), polyvinyl chloride (PVC), styrene butadiene rubber (SBR), polyethylene oxide (PEO), cellulose, or polyacrylate.

In some embodiments, the suspension composition 122 can include a water based polymeric binder. In some embodiments, the water based polymeric binder can include at least one of polyvinyl alcohol (PVOH), polyvinyl acetate (PVAc), polyacrylic acid salt, polyacrylonitrile, polyacrylamide, poly(sodium acrylate-acrylamide-acrylonitrile) copolymer, or copolymers thereof.

In some embodiments, the suspension composition 122 can include a particle suspension agent. In some embodiments, the particle suspension agent can include a stabilization polymer(s) covalently bound to the surface of the shear thickening particles, and/or a stabilizing surfactant. Any suitable particle suspension agent that can be used in the suspension composition 122, for example, any suitable particle suspension agent described in U.S. Pat. No. 10,347,945, issued Jul. 9, 2019, and U.S. Pat. No. 9,760,846, issued Sep. 12, 2017, the disclosure of which are incorporated herein by reference in their entirety, and attached hereto as Exhibit B, and C, respectively.

In some embodiments, the particle suspension agent can include a stabilizing surfactant. In some embodiments, the shear thickening particles 120 can have an electrochemical double layer, and the particle suspension agent can have a chain length of greater than double the thickness of the electrochemical double layer. In some embodiments, the stabilizing surfactant can include a first portion for adsorbing to the particles, and a second portion that is absorbed in the solvent. In some embodiments, a length of the surfactant from the first portion to the second portion can be greater than twice the thickness of the electrochemical double layer.

In some embodiments, the stabilizing surfactant can include a first portion for adsorbing to the shear thickening particles 120, and a second portion that is absorbed in the suspension composition 122. The length of the surfactant from the first portion to the second portion can be greater than twice the thickness of the electrochemical double layer. In some embodiments, the stabilizing surfactants (also commonly known as dispersants) can include one or more type of surfactants. As used herein, the term “surfactants” refers to compounds that lower the surface tension (or interfacial tension) between two liquids or between a liquid and a solid. Surfactants may act as a wetting agent and/or a dispersants. Surfactants are usually organic compounds that are amphiphilic; they contain both hydrophobic groups (the tails) and hydrophilic groups (the heads). Therefore, a surfactant contains both a water-insoluble component and a water-soluble component.

In some embodiments, the stabilizing surfactant can be a polymer with a chain length of at least about 1 nm, at least about 5 nm, at least about 10 nm, at least about 15 nm, at least about 20 nm, at least about 25 nm, at least about 30 nm, at least about 35 nm, at least about 40 nm, at least about 45 nm, at least about 50 nm, at least about 55 nm, at least about 60 nm, at least about 70 nm, or at least about 80 nm. In some embodiments, the stabilizing surfactant can be a polymer with a chain length of no more than about 100 nm, no more than about 90 nm, no more than about 80 nm, no more than about 70 nm, no more than about 60 nm, no more than about 55 nm, no more than about 50 nm, no more than about 45 nm, no more than about 40 nm, no more than about 35 nm, no more than about 30 nm, no more than about 25 nm, no more than about 20 nm, no more than about 15 nm, no more than about 10 nm, no more than about 5 nm, or no more than about 1 nm. Combinations of the above-referenced chain lengths are also possible (e.g., at least about 10 nm and no more than about 100 nm, or at least about 20 nm and no more than about 80 nm), inclusive of all values and ranges therebetween. In some embodiments, the stabilizing surfactant can be a polymer with a chain length of about 1 nm, about 5 nm, about 10 nm, about 15 nm, about 20 nm, about 25 nm, about 30 nm, about 35 nm, about 40 nm, about 45 nm, about 50 nm, about 55 nm, about 60 nm, about 70 nm, about 80 nm, about 90 nm, or about 100 nm, inclusive. In some embodiments, the stabilizing surfactant can also be a polymer including about 1 to about 145 monomer units.

In some embodiments, the stabilizing surfactant is electrochemically stable and electrically insulating. For example, the stabilizing surfactant can be stable to an operating voltage of 4.6 V in a cell. In some embodiments, the stabilizing surfactant can also be ionically conducting.

The stabilizing surfactant can be selected from many different polymers. In some embodiments, the stabilizing surfactant can be a polymer comprising monomer units including at least one of, or be selected from the group consisting of styrenes, acrylates, methacrylates, acrylonitrile, acrylamides, methacrylamides, 4-vinylpyridine, 2,2′-dichloroethene, 2-methyl-1,3-butadiene, acrylic acids, methacrylic acids, vinyl ester, N-vinyl carbazole, and N-vinyl pyrrolidone and mixtures thereof. In some embodiments, the stabilizing surfactant can include poly(methyl methacrylate) (PMMA). Mixtures of surfactants are also possible and can be selected with specific functional groups to optimize interactions with the salts or solvents.

In some embodiments, the stabilizing surfactant can include a polyelectrolyte. The polyelectrolyte can include at least one of, or be selected from the group consisting of pectin, carrageenan, alginates, polyacrylic acid, poly(sodium styrene sulfonate) (PSS), polymethacrylic acid, poly(2-acrylamido-2-methyl-1-propanesulfonic acid), poly(2-acrylamido-2-methyl-1-propanesulfonic acid-co-acrylonitrile), poly(styrene sulfonic acid), poly(4-styrenesulfonic acid-co-maleic acid), and poly(vinylsulfonic acid).

In some embodiments, the shear thickening particles 120 can have an isoelectric point (IEP), and if 6<IEP<12, the surfactant is anionic; if 0<IEP<8, the surfactant is cationic, and if 6≤IEP≤8, the surfactant can be either anionic or cationic. The anionic surfactant can include at least one selected from the group consisting of polyacrylic acid, polystyrene sulfonic acid, esters, polyvinyl sulfonic acid, and alkyl ether phosphate. In some embodiments, the cationic surfactant can include quaternary ammonia. In some embodiments, the surfactant can be nonionic if 0≤IEP≤12. In some embodiments, the nonionic surfactant can include at least one selected from the group consisting of ester and carboxylic acid functionality.

In some embodiments, the stabilizing surfactant can include at least one of sodium dodecyl sulfate, polyethylene glycol, polystyrene sulfonate, alkyl ether phosphate, polyacrylic acid, polyethyleneimine, or various Triton types (X-100, X-102, X-114, X-405).

In some embodiments, the suspension composition 122 can include an electrolyte salt. In some embodiments, the electrolyte salt can include at least one of lithium hexafluorophosphate, lithium triflate, lithium perchlorate, lithium tetrafluoro borate, lithium hexafluoro lithium arsenate, lithium bis(trifluoromethane sulphone)imide, lithium bis(oxalate) borate, sodium perchlorate, sodium tetrafluoro borate, sodium hexafluoro arsenate, sodium bis(trifluoromethane sulphone)imide, sodium bis(oxalate) borate, sodium hexafluorophosphate, or sodium triflate.

In some embodiments, the coating layer 130 can have a thickness of at least about 500 nm, at least about 600 nm, at least about 700 nm, at least about 800 nm, at least about 900 nm, at least about 1 μm, at least about 2 μm, at least about 3 μm, or at least about 4 μm. In some embodiments, the coating layer 130 can have a thickness of no more than about 200 μm, no more than about 175 μm, no more than about 150 μm, no more than about 125 μm, no more than about 100 μm, no more than about 75 μm, no more than about 50 μm, no more than about 25 μm, no more than about 10 μm, no more than about 5 μm, or no more than about 1 μm. Combinations of the above-referenced thicknesses are also possible (e.g., at least about 500 nm and no more than about 200 μm or at least about 1 μm and no more than about 200 μm), inclusive of all values and ranges therebetween.

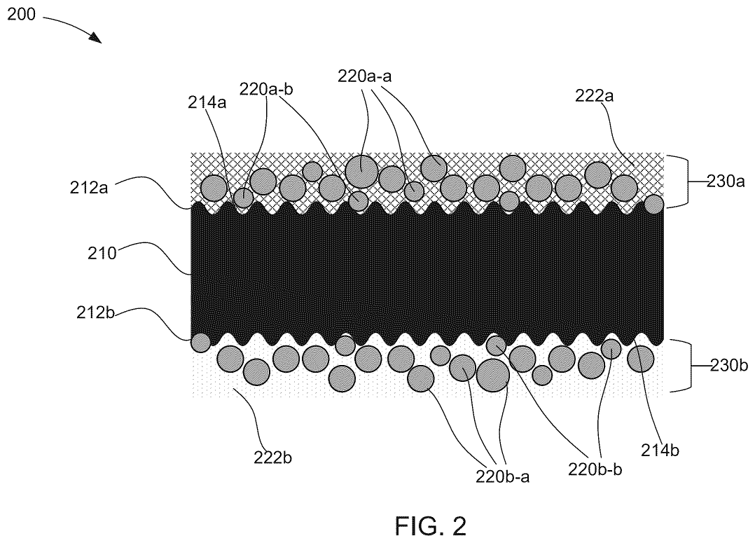

FIG. 2 is a side view of a passively impact-resistant assembly 200 (referred to herein as “assembly 200”), according to an embodiment. The assembly 200 includes a porous substrate 210 having a first surface 212a and a second surface 212b opposite to the first surface. The assembly 200 includes a first plurality of pores 214a distributed throughout the first surface 212a, and a second plurality of pores 214b defined in the second surface 212b, for example, distributed throughout the first surface 212a, and second surface 212b, respectively. The pores 214a, 214b may include cavities defined in the first and second surface 212a, 212b, and/or through holes defined through the substrate 210 (e.g., from the first surface 212a to the second surface 212b). The assembly 200 further includes a first plurality shear thickening particles 220a-a and 220a-b (collectively referred to herein as “shear thickening particles 220a”) and may optionally include a suspension composition 222a in which the first plurality shear thickening particles 220a are suspended and/or dispersed. The assembly 200 further includes a second plurality shear thickening particles 220b-a and 220b-b (collectively referred to herein as “shear thickening particles 220b”) and may optionally include a suspension composition 222b in which the second plurality shear thickening particles 220b are suspended and/or dispersed. As shown in FIG. 2, the shear thickening particles 220a-b, and 220b-b are disposed at least partially in the pores 214a and 214b, respectively. In some embodiments, a coating layer 230b including the second plurality of shear thickening particles 220b and the suspension composition 222b may be disposed on the second surface 212b, for example, distributed throughout the second surface 212b.

As shown in FIG. 2, a first portion of the first plurality of shear thickening particles 220a-a are disposed on or over the first surface 212a (e.g., distributed throughout the first surface 212a), and a second portion of the first plurality of shear thickening particles 220a-b may be at least partially disposed in or within the first pores 214a (e.g., distributed within the first pores 214a). The second portion of the first plurality of shear thickening particles 220a-b may include between about 0 wt. % to about 10 weight percent (wt. %) of the first plurality of shear thickening particles 220a. Similarly, a first portion of the second plurality of shear thickening particles 220b-a are disposed on or over the second surface 212b (e.g., distributed throughout the second surface 212b), and a second portion of the second plurality of shear thickening particles 220b-b are disposed at least partially in or within the second pores 214b (e.g., distributed within the second pores 214b). The second portion of the second plurality of shear thickening particles 220b-b constitutes between about 0 and about 10 weight percent (wt. %) of the second plurality of shear thickening particles 220b. The assembly 200 can have a first coating layer 230a disposed on the first surface 212a and a second coating layer 230b disposed on the second surface 212b. In some embodiments, the shear thickening particles 220a-b and/or 220b-b may not be present within the pores 214a, 214b. That is, in some embodiments, the second portion of the first and/or second plurality of particles 220a-b and/or 220b-b can be about 0 wt. % of the first and/or second plurality of particles 220a and/or 220b, respectively.

In some embodiments, the first surface 212a, the second surface 212b, the first pores 214a, the second pores 214b, the first plurality of particles 220a, the second plurality of particles 220b, the first suspension composition 222a, the second suspension composition 222, the first coating 230a, the second coating 230b, are similar or substantially the same as the surface 112, the pores 114, the plurality of particles 120, the suspension composition 122, and the coating 130, respectfully, as described with respect to FIG. 1.

In some embodiments, the first coating layer 230a is similar or substantially the same as the second coating layer 230b in terms of thickness and/or chemical composition. In some embodiments, the first coating layer 230a may differ from the second coating layer 230b in terms of thickness and/or chemical composition. The first coating layer 230a and the second coating layer 230b may include different solvents, particle loading, and shear-activated particles. In some embodiments, the first plurality of shear thickening particles 220a can be substantially same as the second plurality of shear thickening particles 220b in terms of at least one of particle size distribution, chemical composition, or shape. In some embodiments, the first plurality of shear thickening particles 220a and the second plurality of shear thickening particles 220b can possess substantially same physicochemical properties. In some embodiments, the first plurality of shear thickening particles 220a and the second plurality of shear thickening particles 220b may exhibit different physicochemical properties. That is, in some embodiments, the first plurality of shear thickening particles 220a can differ from the second plurality of shear thickening particles 220b in terms of at least one of particle size distribution, chemical composition, or shape. In some embodiments, the portion of the first plurality of shear thickening particles 220a that are within the pores 214a of the first surface 212a can be substantially same as the portion of the second plurality of shear thickening particles 220b that are within the pores 214b of the second surface 212b. In some embodiments, the portion of the first plurality of shear thickening particles 220a that are within the pores 214a of the first surface 212a can be different from the portion of the second plurality of shear thickening particles 220b that are within the pores 214b of the second surface 212b.

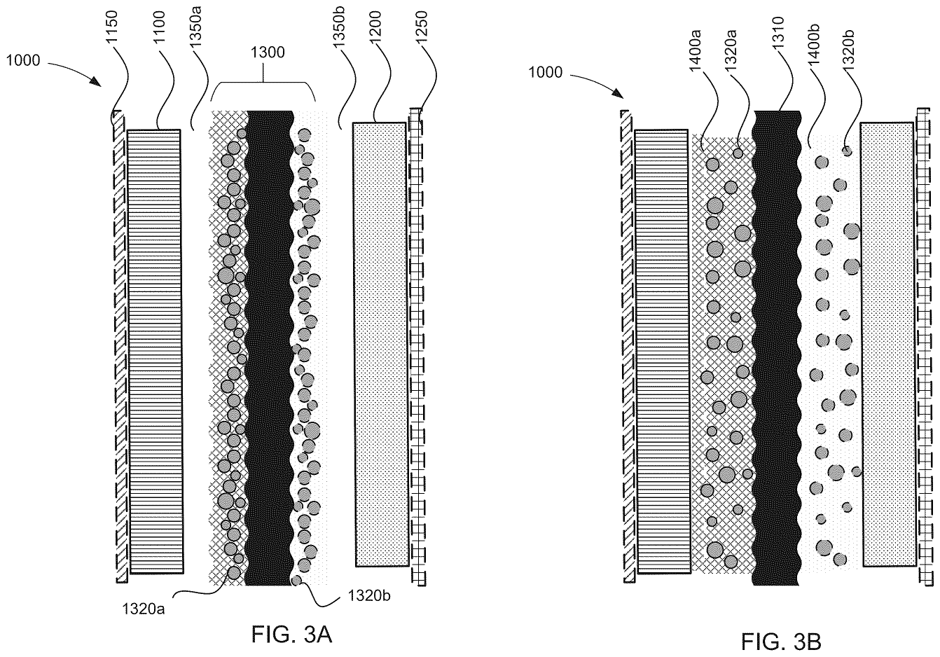

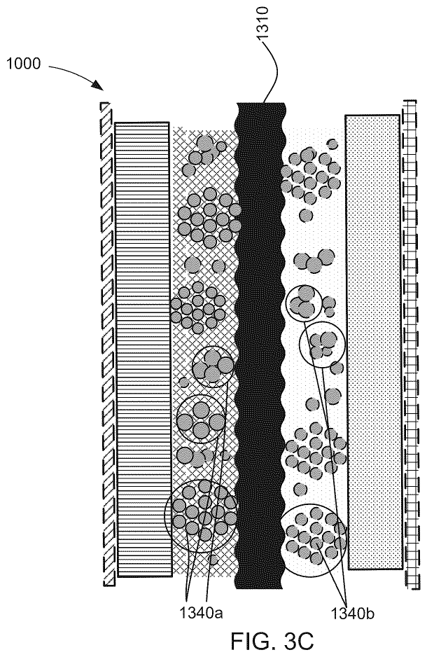

FIG. 3A shows a side view of an electrochemical cell 1000 with a passively impact-resistant assembly 1300 (hereafter referred to as assembly 1300), according to an embodiment. The electrochemical cell 1300 includes an anode 1100 optionally disposed on an anode current collector 1150, and a cathode 1200 optionally disposed on a cathode 1200 current collector 1250. The electrochemical cell 1300 further includes the passively impact resistant assembly 1300. The electrochemical cell 1300 further includes a first space between the anode 1100 and the assembly 1300 and a second space 1350b between the cathode 1200 and the assembly 1300.

In some embodiments, the passively impact-resistant assembly 1300 is similar to or substantially same as the passively impact-resistant assembly 100 as described with respect to FIG. 1. In some embodiments, the passively impact-resistant assembly 1300 is similar to or substantially same as the passively impact-resistant assembly 200 as described with respect to FIG. 2. The assembly 1300 includes a plurality of shear thickening particles 1320a disposed on a first surface of the assembly 1300. The assembly 1300 can optionally include a second plurality of shear thickening particles 1320b disposed on a second surface of the assembly 1300, opposite to the first surface.

The anode 1100, anode current collector 1150, cathode 1200, and cathode current collector 1250 may be selected from any type or configuration of anodes, anode current collectors, cathodes, and cathode current collectors commonly known in the art. Electrodes described herein can be used with various conventional electrode systems. Anode materials can include, for example, graphite, Li, Si, Sn, Cu₂Sb, Mo₃Sb₇, Sb, Cu₆Sn₅, Al, Pt, Au, In, and the like. Cathode materials can include, for example, LiNi₁₁₃Mn₁₁₃Co₁₁₃O₂ (NMC), LiCoO₂, Li(CoAl)₁O₂, Li_{1.2}(MnNiCo)_{0.8}O₂ (AKA Lithium rich), LiMn₂O₄, Li₂MnO₃, LiMn_{1.5}Ni_{0.5}O₄, LiFePO₄, LiCoPO₄, LiNiPO₄, LiNiO₂, Li—V—O, Li₂Si—Mn, Fe, Ni—O₄, NaFeO₂, NaCrO₂, Na(Fe,Mn,Ni,Co)O₂, Na₂(Ni,Fe,Mn)O₄, and the like. In some embodiments, the electrochemical cell 1000 can include self-standing electrodes, i.e., the cathode 1200 and the anode 1100 can be directly interfaced with external electronics without using the cathode current collector 1250 and the anode current collector 1150, respectively. Accordingly, in some embodiments, the current collectors 1150, 1250 are not present within the electrochemical cell 100.

In some embodiments, the first space 1350a and the second space 1350b can include a gaseous mixture. In some embodiments, the first space 1350a and the second space 1350b can include an inert gas or inert gas mixture.

FIG. 3B shows a side view of the electrochemical cell 1000 after addition of an ionically conductive composition, according to an embodiment. Once, an ionically conductive composition 1400a, 1400b (collectively referred to herein as “the ionically conductive composition 1400”) is disposed between the assembly 1300 and at least of one of the anode 1100 or the cathode 1200, the plurality of shear thickening particles disposed and/or adhered onto the assembly 1300 migrate from or diffuse from the assembly 1300 into the ionically conductive composition. In some embodiments, at least about 99 wt %, at least about 98 wt %, at least about 95 wt %, at least about 90 wt %, at least about 85 wt %, at least about 80 wt %, at least about 75 wt %, at least about 70 wt %, at least about 65 wt %, at least about 60 wt %, at least about 55 wt %, or at least about 50 wt %, of the shear thickening particles 1320a and/or 1320b migrate into the ionically conductive composition 1400a and/or 1400b, respectively. Upon migration of the shear thickening particles 1320a and/or 1320b into the ionically conductive composition 1400, a porous substrate 1310, for example, similar to or identical to the porous substrate 110 in FIG. 1, remains between the anode 1100 and cathode 1200.

In some embodiments, the ionically conductive composition 1400 can be an electrolyte composition. In some embodiments, the ionically conductive composition 1400 can include a suspension agent similar to or same as the suspension agent described above with respect to FIG. 1. In some embodiments, the suspension agent concentration can be from about 0.001 wt. % to about 5.0 wt. %, at least about 0.5 wt. %, at least about 1.0 wt. %, at least about 1.5 wt. %, at least about 2.0 wt. %, at least about 2.5 wt. %, at least about 3.0 wt. %, at least about 3.5 wt. %, at least about 4.0 wt. %, or at least about 4.5 wt. %, based on the total weight of the ionically conductive composition 1400. In some embodiments, the suspension agent concentration can be no more than about 5.0 wt. %, no more than about 4.5 wt. %, no more than about 4.0 wt. %, no more than about 3.5 wt. %, no more than about 3.0 wt. %, no more than about 2.5 wt. %, no more than about 2.0 wt. %, no more than about 1.5 wt. %, no more than about 1.0 wt. %, no more than about 0.5 wt. %, or no more than about 0.001 wt. %, based on the total weight of the ionically conductive composition 1400. Combinations of the above-referenced concentrations are also possible (e.g., at least about 1.0 wt. % and no more than about 4.0 wt. % or at least about 2.0 wt. % and no more than about 3.5 wt. %), inclusive of all values and ranges therebetween. In some embodiments, the suspension agent concentration can be about 0.001 wt. %, about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, or about 5.0 wt. %, or within a range of any high and low value among these, based on the total weight of the ionically conductive composition 1400.

The shear thickening particles 1320a and/or 1320b within the ionically conductive composition 1400 can have an absolute zeta potential of greater than +30 mV, at least about +35 mV, at least about ±40 mV, at least about ±45 mV, at least about ±50 mV, at least about ±55 mV, or at least about ±60 mV. The shear thickening particles 1320a, 1320b within the ionically conductive composition 1400 can have an absolute zeta potential of greater than ±30 mV, at least about ±35 mV, at least about ±40 mV, at least about ±45 mV, at least about ±50 mV, at least about ±55 mV, or at least about ±60 mV, inclusive. Combinations of the above-referenced zeta potential values are also possible (e.g., at least about ±40 mV and no more than about ±60 mV or at least about ±50 mV and no more than about ±55 mV, inclusive), inclusive of all values and ranges therebetween. In some embodiments, the shear thickening particles 1320a and/or 1320b within the ionically conductive composition 1400 can have an absolute zeta potential of about ±30 mV, about ±35 mV, about ±40 mV, about ±45 mV, about ±50 mV, about ±55 mV, or about ±60 mV, inclusive. The shear thickening particles within the ionically conductive composition 1400 can have an absolute zeta potential of about ±30 mV, about ±35 mV, about ±40 mV, about ±45 mV, about ±50 mV, about ±55 mV, or about ±60 mV, inclusive.

The shear thickening particles 1320a and/or 1320b can be present in the ionically conductive composition 1400a and/or 1400b from about 10 wt. % to about 80 wt. %, at least about 15 wt. %, at least about 20 wt. %, at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 70 wt. %, or at least about 75 wt. %, inclusive based on the total weight of the ionically conductive composition 1400a and/or 1400b. The shear thickening particles 1320a and/or 1320b can also be present in the ionically conductive composition 1400a and/or 1400b in amounts no more than about 80 wt. %, no more than about 75 wt. %, no more than about 70 wt. %, no more than about 65 wt. %, no more than about 60 wt. %, no more than about 55 wt. %, no more than about 50 wt. %, no more than about 45 wt. %, no more than about 40 wt. %, no more than about 35 wt. %, no more than about 30 wt. %, no more than about 25 wt. %, no more than about 20 wt. %, or no more than about 15 wt. %, inclusive based on the total weight of the ionically conductive composition 1400a and/or 1400b. Combinations of the above-referenced concentrations are also possible (e.g., at least about 20 wt. % and no more than about 70 wt. % or at least about 30 wt. % and no more than about 60 wt. %), inclusive of all values and ranges therebetween. In some embodiments, the shear thickening particles 1320a and/or 1320b can be present in the ionically conductive composition 1400a and/or 1400b at about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, or about 80 wt. %, or within a range of any high and low value among these, based on the total weight of the ionically conductive composition 1400a and/or 1400b.

In some embodiments, the ionically conductive composition 1400 can include an electrolyte salt. Any conventional lithium ion battery electrolyte salt can be used for the ionically conductive composition 1400. Suitable electrolyte salts include, but are not limited to, for example, lithium hexafluorophosphate, lithium triflate, lithium perchlorate, lithium tetrafluoro borate, lithium hexafluoro lithium arsenate, lithium bis(trifluoromethane sulphone)imide, and lithium bis(oxalate) borate, and combinations of any of the foregoing. Sodium salts can also be used, and can include, for example, sodium perchlorate, sodium tetrafluoro borate, sodium hexafluoro arsenate, sodium bis(trifluoromethane sulphone)imide, sodium bis(oxalate) borate, and combinations of any of the foregoing.

In some embodiments, the ionically conductive composition 1400 can include an electrolyte solvent. Any conventional lithium ion battery electrolyte solvent can be used for the ionically conductive composition 1400. Suitable electrolyte solvents include, but are not limited to, for example, ethylene carbonate, dimethyl carbonate, propylene carbonate, dimethoxyethane, dioxolane, ethyl methyl carbonate, various ionic liquids, and combinations of any of the foregoing. Examples of ionic liquids include, but are not limited to, for example, N-alkyl-N-methylpyrrolidinium bis(trifluoromethanesulfonyl)-imide, N-alkyl-N-methylpyrrolidinium bis(fluorosulfonyl)imide, and 1-ethyl-3-methyl-imidazolium bis(trifluoromethanesulfonyl)imide. A mixture of ethylene carbonate and dimethyl carbonate is often used as a solvent in preparing electrolytes, a commonly used mixture being 3:7 weight % ratio mixture of ethylene carbonate and dimethyl carbonate (for example, a mixture containing 30 grams ethylene carbonate and 70 grams dimethyl carbonate), referred to elsewhere herein as 3:7 EC/DMC.

In some embodiments, the ionically conductive composition 1400 can include an electrolyte additive. Conventional electrolyte additives may also be used; examples include, but are not limited to fluorinated ethylene carbonate, vinyl carbonate to promote solid electrolyte interface (SEI) formation on the anode or cathode with no substantial effect on shear thickening.

In some embodiments, the ionically conductive composition 1400 can include no more than about 10M, no more than about 8 M, no more than about 6M, no more than about 4M, no more than about 2M, or no more than about 1M, inclusive of an electrolyte salt. Combinations of the above-referenced thicknesses are also possible (e.g., at least about 0.1M and no more than about 10M, or at least about 1M and no more than about 6M), inclusive of all values and ranges therebetween.

In some embodiments, the ionically conductive composition 1400 can include a binder selected from at least one of polyvinylidene fluoride (PVDF), polyethylene oxide (PEO), polyacrylic acid (PAA), styrene-butadiene rubber (SBR), carboxymethyl cellulose (CMC), or polysulfone (PSU).

FIG. 3C is an illustration of the electrochemical cell 1000 of FIG. 3B after receiving an impact. The shear thickening particles 1320a and/or 1320b form into a plurality agglomerates 1340a, 1340b, respectively, upon receiving an impact. In some embodiments, the impact includes shear induced stress causing the ionically conductive composition 1400a and/or 1400b to have a shear rate of at least about 30 s⁻¹, at least about 40 s⁻¹, at least about 50 s⁻¹, at least about 60 s⁻¹, at least about 70 s⁻¹, at least about 80 s⁻¹, at least about 90 s⁻¹, at least about 100 s⁻¹, at least about 110 s⁻¹, at least about 120 s⁻¹, at least about 130 s⁻¹, at least about 140 s⁻¹, at least about 150 s⁻¹, at least about 160 s⁻¹, at least about 170 s⁻¹, at least about 180 s⁻¹, at least about 190 s⁻¹, or at least about 200 s⁻¹, inclusive.

In some embodiments, the plurality of agglomerates 1340a and/or 1340b within the ionically conductive composition 1400 can be defined by the number of particles they contain. For instance, an agglomerate may be considered as a cluster of at least about 3 particles, at least about 5 particles, at least about 10 particles, at least about 20 particles, at least about 50 particles, or at least about 100 particles, inclusive. Agglomerates can also be characterized by having no more than about 200 particles, no more than about 150 particles, no more than about 100 particles, no more than about 50 particles, or no more than about 20 particles, inclusive.

In some embodiments, the plurality of agglomerates 1340a and/or 1340b can have an average longest dimension of at least about 0.1 μm, at least about 0.5 μm, at least about 1 μm, at least about 5 μm, at least about 10 μm, at least about 30 μm, at least about 50 μm, at least about 60 μm, at least about 70 μm, at least about 80 μm, at least about 90 μm, at least about 100 μm, at least about 200 μm, at least about 300 μm, at least about 400 μm, or at least about 500 μm, inclusive.

In some embodiments, the plurality of agglomerates 1340a and/or 1340b can have an average longest dimension of no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 5 μm, no more than about 1 μm, no more than about 0.5 μm, or no more than about 0.1 μm, inclusive. Combinations of the above-referenced dimensions are also possible (e.g., at least about 0.1 μm and no more than about 500 μm or at least about 10 μm and no more than about 100 μm), inclusive of all values and ranges therebetween. In some embodiments, the plurality of agglomerates 1340a and/or 1340b can have an average longest dimension of about 0.1 μm, about 0.5 μm, about 1 μm, about 5 μm, about 10 μm, about 30 μm, about 50 μm, about 60 μm, about 70 μm, about 80 μm, about 90 μm, about 100 μm, about 200 μm, about 300 μm, about 400 μm, or about 500 μm, inclusive. In some embodiments, the average longest dimension can be determined by intensity average particle size (Z average) as measured by dynamic light scattering. In some embodiments, the average longest dimension can be determined by a number reference particle size measured by dynamic light scattering. In embodiments, the average longest dimension can be determined by transmission electron microscopy.

In some embodiments, the portion of the active material that is formed into of the plurality of agglomerates (i.e., the portion of the active material that is not freely scattered away from the agglomerates) is at least at least about 30%, at least about 35%, at least about 40%, at least about 45%, at least about 50%, at least about 55%, at least about 60%, at least about 65%, at least about 70%, at least about 75%, or at least about 80%, inclusive of the active material.

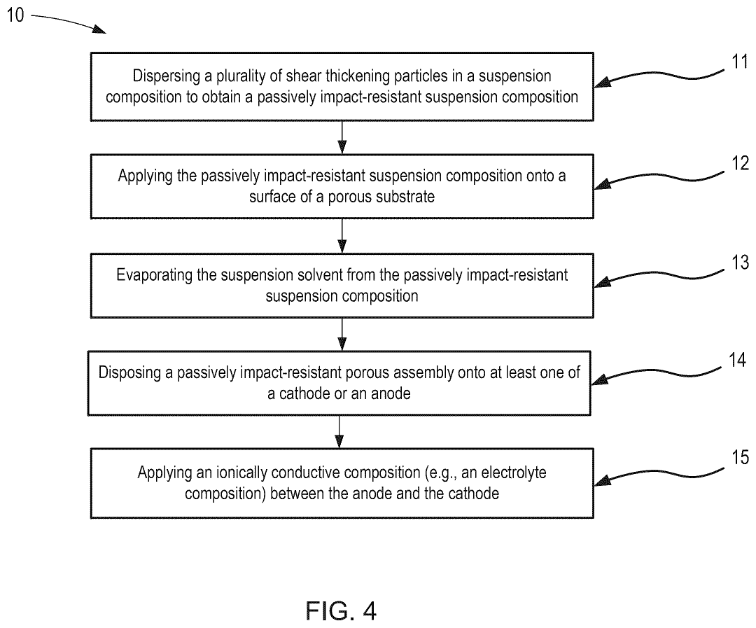

FIG. 4 is a block diagram of a method 10 for forming electrochemical cell with a passively impact-resistant electrolyte, according to an embodiment. The method 10 includes dispersing a plurality of shear thickening particles in a suspension composition, at 11, to obtain a passively impact-resistant suspension composition. The method 10 further includes applying the passively impact-resistant suspension composition onto a surface of a porous substrate, at 12. The method 10 includes evaporating a suspension solvent from the passively impact-resistant suspension composition, at 13, to form a passively impact-resistant porous assembly such that a first portion of the plurality of shear thickening particles are distributed throughout the surface of the porous substrate, and a second portion of the plurality of shear thickening particles are distributed within pores of the porous substrate. The method 10 can further include disposing a passively impact-resistant porous assembly onto at least one of a cathode or an anode, at 14. The method 10 further includes applying an ionically conductive composition (e.g., an electrolyte composition) between the anode and the cathode, at 15, to form a passively impact-resistant electrochemical cell. In some embodiments, the passively impact-resistant porous assembly, the porous substrate, the plurality of shear thickening particles, the suspension composition, and suspension solvent are same or substantially similar to the passively impact-resistant porous assembly 100, the porous substrate 110, the plurality of shear thickening particles 120, the suspension composition 122, and the suspension solvent, respectively, described with respect to FIG. 1.

At operation 11, the method 10 may include dispersing a plurality of shear thickening particles in a suspension composition to obtain a passively impact-resistant suspension composition. Dispersion of the shear thickening particles can be assisted by sonication, shaking or other vibrations. Mixing can be promoted by heating, for example, heating to at least about 30° C., at least about 40° C., at least about 50° C., at least about 60° C., at least about 70° C., or at least about 80° C., inclusive to promote mixing. In some embodiments, dispersion may occur in a controlled environment (e.g., an inert environment, an environment with pre-determined humidity) to maintain the stability of the shear thickening particles, with the temperature carefully controlled to ensure uniform dispersion and prevent premature agglomeration or sedimentation.

In some embodiments, dispersing a plurality of shear thickening particles in a suspension composition can include sonicating the passively impact-resistant suspension composition. In some embodiments, dispersing a plurality of shear thickening particles in a suspension composition can include using an ultrasonic wand to ensure homogenous distributions. A suspension composition with a high particle content (e.g. more than 90 wt. %) may undergo rapid shear thickening, rendering it challenging to apply uniformly to the porous substrate. Conversely, a suspension composition with a low particle concentration may not be effective for creating a pronounced shear thickening effect (e.g., viscosity increase by at least two-fold). In some embodiments, the shear thickening particles can be present in the suspension composition in an amount ranging from about 20 wt. % to about 80 wt. % based on the total weight of the suspension composition.

Operation 12 can involve applying the passively impact-resistant suspension composition (hereafter referred to as the suspension composition) onto the surface of a porous substrate. The application can be performed using a variety of processes, such as a roll-to-roll process including slot die coating and tape casting. In some embodiments, the passively impact-resistant suspension composition can be applied in-line via a roll-to-roll process. In some embodiments, the passively impact-resistant suspension composition can be applied via a Mayer coating rod, a micro-gravure, a doctor blade, a gravure, a spray coating, and/or an ink jet coating.

In some embodiments, the surface can be a first surface, and a non-porous backing may be placed onto a second surface, opposite to the first surface, prior to applying the suspension composition. The non-porous backing can be removed after the suspension solvent evaporates to ensure uniform particle distribution.

In some embodiments, the method 10 can include pre-wetting the porous substrate with a wetting solvent prior to the application of the suspension composition to the porous substrate (not shown in FIG. 4). In some embodiments, the pre-wetting solvent can fill the pores of the porous substrate. The pre-wetting solvent can be the same as the suspension solvent, a different solvent, or mixtures of solvents. If the porous substrate is not pre-wetted, it is possible that the suspension composition could dry immediately upon contact with the porous substrate, and a thin, uniform layer is not achievable. In some embodiments, the non-porous backing can also be applied prior to the pre-wetting of the porous substrate. This can keep the pre-wetting solvent in the pores as the suspension composition is applied to the porous substrate.

At operation 13, the method 10 can include evaporating the suspension solvent from the passively impact-resistant suspension composition to form a passively impact-resistant porous assembly. In some embodiments, the drying is performed under a controlled environment. If evaporation rate is too fast, this can result in cracking of the coating of the suspension composition, while a rate that is too slow may lead to uncontrolled agglomeration of the shear thickening particles. The evaporation process should ensure that the shear thickening particles are evenly distributed along the surface of the porous substrate.

Operation 14 can involve disposing the passively impact-resistant porous assembly onto at least one of a cathode or an anode, thereby creating a dry electrochemical cell. This step requires precise alignment of the coated porous substrate onto the anode or cathode layer, ensuring proper integration into the electrochemical cell. The alignment is crucial for the shear thickening particles to effectively provide mechanical impact resistance. The anode and cathode of the battery can be made of conventional materials. The anode can include at least one selected from the group consisting of graphite, Li, Si, Sn, Cu₂Sb, Mo₃Sb₇, Sb, CusSn₅, Al, Pt, Au, and In. The cathode can include at least one selected from the group consisting of LiNi_{1/3}Mn_{1/3}Co_{1/3}O₂, LiCoO₂, Li(CoAl)₁O₂, Li_{1.2}(MnNiCo)_{0.8}O₂, LiMn₂O₄, Li₂MnO₃, LiMn_{1.5}Ni_{0.5}O₄, LiFePO₄, LiCoPO₄, LiNiPO₄, LiNiO₂, Li—V—O, Li₂Si—Mn, Fe, Ni—O₄, NaFeO₂, NaCrO₂, Na (Fe,Mn,Ni,Co)O₂, and Na₂ (Ni,Fe,Mn)O₄. The use of other anode and cathode materials well-known in the art is possible.

At operation 15, the method includes applying an ionically conductive composition (e.g., an electrolyte composition) between the anode and the cathode to form a passively impact-resistant electrochemical cell. The ionically conductive composition can be in a liquid or liquid-like form.

In some embodiments, applying an ionically conductive composition between the anode and the cathode can include injecting the ionically conductive composition into the dry electrochemical cell between the anode and the cathode. In some embodiments, applying an ionically conductive composition between the anode and the cathode include soaking the dry electrochemical cell into the ionically conductive composition.

In some embodiments, the electrolyte composition can include an electrolyte solvent. In some embodiments, the electrolyte solvent can include a non-aqueous electrolyte. In some embodiments, the non-aqueous electrolyte can include ethylene carbonate (EC), gamma-butyrolactone (GBL), Lithium bis(fluorosulfonyl)imide (LiFSI), trioctyl phosphate (TOP), propylene carbonate (PC), dimethoxyethane (DME), bis(trifluoromethanesulfonyl)imide (TSFI), Li_{1.4}Al_{0.4}Ti_{1.6}(PO₄)₃ (LATP), or any suitable combinations thereof.

In some embodiments, the electrolyte composition can include at least about 0.1M, at least about 0.25M, at least about 0.5M, at least about 1M, at least about 2M, or at least about 3M, inclusive of an electrolyte salt. In some embodiments, the electrolyte composition can include no more than about 10M, no more than about 8 M, no more than about 6M, no more than about 4M, no more than about 2M, or no more than about 1M, inclusive of an electrolyte salt. Combinations of the above-referenced thicknesses are also possible (e.g., at least about 0.1M and no more than about 10M or at least about 1M and no more than about 6M), inclusive of all values and ranges therebetween. During this step, the shear thickening particles disposed onto the porous substrate may be wetted by the electrolyte, forming a shear thickening electrolyte solution in situ, which can lead to the impact-resistant properties of the cell as described above with respect to FIGS. 3A and 3B.

In some embodiments, the electrolyte composition can further include a counter ion including at least one of, or selected from the group consisting of H⁺, Li⁺, and Na⁺, for example, when the electrolyte composition includes an anionic surfactant. The counter ions can promote interaction with the liquid part of the battery electrolyte and may also contribute to the conductivity of the electrolyte. In some embodiments, the electrolyte composition can further include, in addition to the electrolyte salt, a salt including at least one of, or selected from the group consisting of PF₆, ClO₄, BF₄, bis(trifluoromethane) sulfonimide, triflate, bioxoborate, and maloborate. Such salts can promote interaction with the liquid part of the battery electrolyte or aid in ion transport by pinning the anion, for example, in electrolyte compositions including a cationic surfactant.

The passively impact-resistant electrochemical cell formed using the method 10 can have any suitable geometry including pouch, prismatic geometry, and cylindrical geometry designs. Moreover, the passively impact-resistant electrochemical cell can be any battery type, which incorporate a non-solid electrolyte. The method 10 can be used to form laminated batteries, batteries with cast electrodes, vapor deposited electrodes, electrodeposited electrodes, laminated electrodes, thin films made by sputtering or other deposition processes, and 3D batteries. The passively impact-resistant electrochemical cell can include a current collector, or a free standing electrode which do not have a current collector.

The passively impact-resistant electrochemical cell obtained via method 10 can be used in a battery pack with both shear thickening and regular electrolyte (e.g., non-shear thickening electrolyte) arrangements. For example, an outside surface or region of the battery pack can be protected with the shear thickening electrolyte composition, while a center region of the battery pack, where impacts are less of a concern, can use non-shear thickening electrolyte.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An assembly, comprising:
a porous substrate having a surface and defining pores therein; and
a plurality of shear thickening particles disposed on or over the surface and the pores, and configured to form agglomerates upon receiving an impact while suspended in a liquid or semi-liquid composition.

2. The assembly of claim 1, wherein the pores have an average pore diameter, and the agglomerates have an average agglomerate diameter greater than the average pore diameter.

3. The assembly of claim 1, wherein the porous substrate is an electrically insulating separator.

4. The assembly of claim 1, wherein the plurality of shear thickening particles have an average particle size in a range of about 50 nm to about 1 μm.

5. The assembly of claim 1, wherein the plurality of shear thickening particles are electrically non-conducting.

6. The assembly of claim 5, wherein the plurality of shear thickening particles include at least one of TiO₂, Al₂O₃, ZrO₂, Y₂O₃, HfO₂, GeO₂, Sc₂O₃, CeO₂, MgO, BN or SiO₂.

7. The assembly of claim 1, wherein the plurality of shear thickening particles have a polydispersity index of no greater than 0.2.

8. The assembly of claim 1, further comprising:
a binder configured to facilitate adhesion of the plurality of shear thickening particles on the surface.

9. The assembly of claim 1, wherein the surface is a first surface, the plurality of shear thickening particles is a first plurality of shear thickening particles, and the porous substrate includes a second surface opposite the first surface, the second surface also defining pores therein, the assembly further comprising:
a second plurality of shear thickening particles disposed on or over the second surface and the corresponding pores, the second plurality of shear thickening particles configured to form agglomerates upon receiving an impact while suspended in a liquid or semi-liquid composition.

10. An assembly, comprising:
a porous substrate having a surface and defining pores therein; and
a plurality of shear thickening particles including a first portion and a second portion, the first portion disposed on or over the surface and the pores, and the second portion disposed at least partially in the pores,
the second portion of the plurality of shear thickening particles including less than 10% of a total mass of the first portion and the second portion of the shear thickening particles,
the first portion of the shear thickening particles configured to form agglomerates upon receiving an impact while suspended in a liquid or semi-liquid composition.

11. The assembly of claim 10, wherein the pores have an average pore diameter, and the agglomerates have an average agglomerate diameter greater than the average pore diameter.

12. The assembly of claim 10, wherein the porous substrate is an electrically insulating separator.

13. The assembly of claim 10, wherein the plurality of shear thickening particles have an average particle size in a range of about 50 nm to about 1 μm.

14. The assembly of claim 10, wherein the plurality of shear thickening particles are electrically non-conducting.

15. The assembly of claim 14, wherein the plurality of shear thickening particles include at least one of TiO₂, Al₂O₃, ZrO₂, Y₂O₃, HfO₂, GeO₂, Sc₂O₃, CeO₂, MgO, BN or SiO₂.

16. The assembly of claim 10, wherein the plurality of shear thickening particles have a polydispersity index of no greater than 0.2.

17. The assembly of claim 10, further comprising:
a binder configured to facilitate adhesion of the plurality of shear thickening particles on the surface.

18. The assembly of claim 10, wherein the surface is a first surface, the plurality of shear thickening particles is a first plurality of shear thickening particles, and the porous substrate includes a second substrate opposite the first surface, the second surface also defining pores therein, the assembly further comprising:
a second plurality of shear thickening particles including a first portion and a second portion, the first portion of the second plurality of shear thickening particles disposed on and over the second surface and the corresponding pores,
the second portion disposed at least partially within the pores of the second surface, the second portion of the second plurality of shear thickening particles including less than 10% of the total mass of the first portion and the second portion of the second shear thickening particles,
the first portion of the second shear thickening particles configured to form a second plurality of agglomerates upon receiving an impact while suspended in a liquid or semi-liquid composition.

19. The assembly of claim 18, wherein the pores of the second surface have an average pore diameter, and the second plurality of agglomerates have an average agglomerate diameter greater than the average pore diameter.

20. The assembly of claim 18, wherein the second plurality of shear thickening particles have an average particle size in a range of about 50 nm to about 1 μm.
